(19) United States
(12) Patent Application Publication
(10) Pub. No.: US 2025/0060942 A1
(43) Pub. Date: Feb. 20, 2025

(54) GENERATING IDEATION SCENARIOS BASED ON INTENTS ASSOCIATED WITH REQUIREMENTS

(71) Applicant: International Business Machines Corporation, Armonk, NY (US)

(72) Inventors: Sarika Sinha, Bangalore (IN); Siddharth K. Saraya, Raniganj (IN)

(21) Appl. No.: 18/233,958

(22) Filed: Aug. 15, 2023

(51) Int. Cl. G06F 8/10; G06F 8/35; G06F 11/36

(52) U.S. Cl. CPC G06F 8/10; G06F 8/35; G06F 11/3664

(57) ABSTRACT

A computer-implemented method, system, and computer program product for generating ideation scenarios. A requirement to be used in ideation is received. The intent associated with the received requirement is then identified. An intent refers to the actions to be performed to accomplish the purpose or objective of the requirement. Each intent is associated with a requirement as well as one or more inputs and a final output. A pre-requirement and a post-requirement to the received requirement are then identified. Upon identifying such requirements, the intents associated with such requirements are identified. Upon identifying the intents, such as for the received requirement and the pre- and post-requirements, such intents are joined to generate ideation scenarios in terms of actions. An ideation scenario refers to the idea or solution based on a requirement, where the ideation scenario includes the intents along with the associated requirements, inputs and final outputs.

### TECHNICAL FIELD

The present disclosure relates generally to software development tools, and more particularly to generating ideation scenarios based on intents associated with requirements.

### BACKGROUND

Software development is the process of conceiving, specifying, designing, programming, documenting, testing, and bug fixing involved in creating and maintaining applications, frameworks, or other software components. Software development involves writing and maintaining the source code, but in a broader sense, it includes all processes from the conception of the desired software through the final manifestation, typically in a planned and structured process often overlapping with software engineering. Software development also includes research, new development, prototyping, modification, reuse, re-engineering, maintenance, or any other activities that result in software products.

### SUMMARY

In one embodiment of the present disclosure, a computer-implemented method for generating ideation scenarios comprise receiving a requirement to be used in ideation. The method further comprises identifying a first intent associated with the received requirement. The method additionally comprises identifying a pre-requirement and a post-requirement to the received requirement from a list of requirements. Furthermore, the method comprises identifying a second intent associated with the pre-requirement and a third intent associated with the post-requirement. Additionally, the method comprises generating ideation scenarios in terms of actions based on the first, second and third intents.

Other forms of the embodiments of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the ideation generator to generate ideation scenarios based on intents in accordance with an embodiment of the present disclosure;

FIG. 3 is a table illustrating the requirements for different generated ideation scenarios as well as the scores assigned to such requirements in how well such requirements are met by the generated ideation scenarios in accordance with an embodiment of the present disclosure;

FIG. 4 illustrates an embodiment of the present disclosure of the hardware configuration of the ideation generator which is representative of a hardware environment for practicing the present disclosure;

FIG. 5 is a flowchart of a method for generating ideations based on intents associated with requirements in accordance with an embodiment of the present disclosure;

FIG. 6 is a flowchart of a method for identifying relevant ideation scenarios across industries and domains in accordance with an embodiment of the present disclosure; and

FIG. 7 is a flowchart of a method for handling feedback regarding the presented ideation scenarios in accordance with an embodiment of the present disclosure.

### DETAILED DESCRIPTION

As stated above, software development is the process of conceiving, specifying, designing, programming, documenting, testing, and bug fixing involved in creating and maintaining applications, frameworks, or other software components. Software development involves writing and maintaining the source code, but in a broader sense, it includes all processes from the conception of the desired software through the final manifestation, typically in a planned and structured process often overlapping with software engineering. Software development also includes research, new development, prototyping, modification, reuse, re-engineering, maintenance, or any other activities that result in software products.

Various software tools, such as software development tools, have been developed to assist the user in software development. For example, such software tools may help software developers create, debug, maintain, or otherwise support other programs and applications. Examples of such software development tools include a source code editor and a compiler or interpreter, which are used ubiquitously and continuously. Other software development tools are used more or less depending on the language, development methodology, and individual engineer, often used for a discrete task, such as a debugger or profiler. Software development tools may be discrete programs, executed separately—often from the command line—or may be parts of a single large program, called an integrated development environment (IDE).

Furthermore, such software development tools assist the software developer in designing, coding and testing, such as from the requirements inputted by the software developer. Designing refers to the process in creating digital designs for a variety of purposes. Coding refers to creating the programming code which provides instructions to a computing device to perform certain actions. Testing refers to the process of evaluating and verifying that a software or application does what it is supposed to do.

While such software development tools assist the software developer in designing, coding, and testing, such software development tools do not assist the software developer in ideating (generating ideas) or generating such designs, code, and tests based on such ideations. Ideation is the process of generating ideas and solutions. By not generating such ideations or taking into consideration such ideations, the assistance provided by the software development tool in designing, coding, and testing is limited.

As a result, such software development tools are deficient in assisting users, such as software developers, in designing, coding, and testing by not ideating or generating designs, code, and tests based on such ideations.

The embodiments of the present disclosure provide a means for generating ideations as well as generating designs, code, and tests based on such ideations. In one embodiment, a requirement is received from a user, such as from a software developer. A requirement, as used herein, refers to a necessary condition that is required in the design, code, and/or test. In one embodiment, each requirement is associated with an intent. Hence, based on the inputted requirement, the intent associated with such a requirement is identified. An intent, as used herein, refers to the actions to be performed to accomplish the purpose or objective of the requirement. For example, suppose a requirement is to have a user log into the system using his/her user identification and password. Then the intent associated with such a requirement is to have a correct set of user identification and password in order to allow the user to log into the system. Otherwise, the user will be prevented from logging into the system. Such an intent is also associated with one or more inputs (e.g., user identification, password) and a final output (e.g., logging into the system). Together, such intent, one or more inputs, a final output and requirement form an ideation scenario. An ideation scenario, as used herein, refers to an idea or solution based on a requirement. In one embodiment, upon receiving a requirement, a pre-requirement and a post-requirement is identified, such as from a list of requirements. In one embodiment, a database stores a list of requirements, where a pre-requirement corresponds to a requirement that is listed prior to the received requirement in the list of requirements and a post-requirement corresponds to a requirement that is listed after the received requirement in the list of requirements. In one embodiment, the intents associated with such requirements are identified. Such intents may then be joined forming ideation scenarios in terms of actions based on the joined intents. In one embodiment, such ideation scenarios may be presented to the user (e.g., software developer). Furthermore, code, designs and/or testing for one or more of the presented ideation scenarios may be generated for the user (e.g., software developer). In this manner, the deficiency in software development tools is overcome by generating ideas as well as generating designs, code, and tests based on such ideations. A further discussion regarding these and other features is provided below.

In some embodiments of the present disclosure, the present disclosure comprises a computer-implemented method, system, and computer program product for generating ideation scenarios. In one embodiment of the present disclosure, a requirement to be used in ideation is received. A requirement, as used herein, refers to a necessary condition that is required in the design, code, and/or test. The intent associated with the received requirement is then identified. An intent, as used herein, refers to the actions to be performed to accomplish the purpose or objective of the requirement. For example, suppose a requirement is to have a user log into the system using his/her user identification and password. Then the intent associated with such a requirement is to have a correct set of user identification and password in order to allow the user to log into the system. Otherwise, the user will be prevented from logging into the system. In one embodiment, each intent is associated with a requirement as well as one or more inputs and a final output. A pre-requirement and a post-requirement to the received requirement are then identified from a list of requirements. A pre-requirement, as used herein, refers to the requirement that is listed prior to the received requirement in the list of requirements. A post-requirement, as used herein, refers to the requirement that is listed after the received requirement in the list of requirements. Upon identifying the pre- and post-requirements, the intents associated with such requirements are identified. Upon identifying the intents for the received requirement and the pre- and post-requirements, such intents are joined to generate ideation scenarios in terms of actions based on such joined intents. An ideation scenario, as used herein, refers to the idea or solution based on a requirement. In one embodiment, such ideation scenarios include the intents along with the associated requirements, inputs and final outputs. In this manner, the deficiency in software development tools is overcome by generating ideas as well as generating designs, code, and tests based on such ideations.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

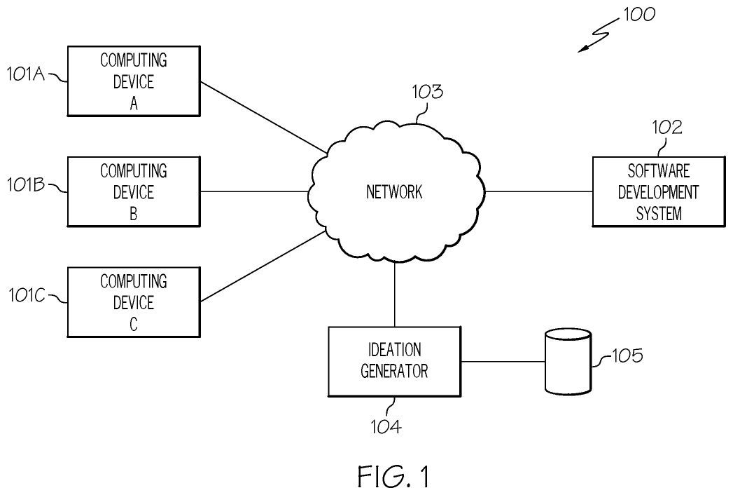

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a software development system 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance, and the like) configured with the capability of connecting to network 103 and consequently communicating with other computing devices 101 and software development system 102. It is noted that both computing device 101 and the user of computing device 101 may be identified with element number 101.

Software development system 102 is a system utilized, such as by software programmers and software developers (e.g., users of computing devices 101), in the process of creating, designing, deploying, and supporting software. Examples of such software development systems, can include, but are not limited to, RAD Studio®, Embold®, Collaborator®, Studio 3T®, NetBeans®, Zend Studio®, Microsoft® Expression Studio, etc.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 further includes an ideation generator 104 configured to generate ideation scenarios based on intents. An ideation scenario, as used herein, refers to an idea or solution based on a requirement. A requirement, as used herein, refers to a necessary condition that is required in the design, code, and/or test. An intent, as used herein, refers to the actions to be performed to accomplish the purpose or objective of the requirement. For example, suppose a requirement is to have a user log into the system using his/her user identification and password. Then the intent associated with such a requirement is to have a correct set of user identification and password in order to allow the user to log into the system. Otherwise, the user will be prevented from logging into the system. Such an intent is also associated with one or more inputs (e.g., user identification, password) and a final output (e.g., logging into the system). Together, such intent, one or more inputs, a final output and requirement form an ideation scenario.

Furthermore, in one embodiment, ideation generator 104 is configured to generate ideation scenarios based on identifying a pre-requirement and a post-requirement to a requirement received from a user, such as the user of computing device 101. In one embodiment, a list of requirements is stored in a database 105 connected to ideation generator 104. In one embodiment, each requirement in the list of requirements is associated with an intent, which may also be stored in database 105. Furthermore, in one embodiment, each intent is associated with one or more inputs and a final output, which may also be stored in database 105.

In one embodiment, such requirements in the list of requirements are logically connected in terms of the intents associated with such requirements. For example, the requirements listed prior and after a requirement are all logically connected in terms of the intents associated with such requirements. For instance, such intents may be directed to actions to be performed to accomplish the purpose or objective of the requirements pertaining to user access of webpages. In one embodiment, such a list of requirements is populated by an expert.

As previously discussed, a pre-requirement and a post-requirement are identified in response to receiving a requirement from a user, such as the user of computing device 101. A pre-requirement refers to a requirement that is listed prior to the received requirement in the list of requirements. A post-requirement refers to a requirement that is listed after the received requirement in the list of requirements. As also previously discussed, each requirement is associated with an intent. As a result, in one embodiment, ideation generator 104 is configured to identify the intents associated with such pre- and post-requirements.

In one embodiment, ideation generator 104 is configured to generate ideation scenarios based on the intents of the received requirement and the pre- and post-requirements by joining such intents. Such ideation scenarios may then be presented to the user, such as the user of computing device 101.

In one embodiment, ideation generator 104 is configured to generate code, designs, and/or tests for the presented ideation scenarios.

In one embodiment, ideation generator 104 is configured to prioritize the generated ideation scenarios based on the weights assigned to the requirements (e.g., security, usability, performance, internationalization, etc.) corresponding to a level of priority. In one embodiment, such weights are provided by the user (e.g., software developer) of computing device 101. Upon prioritizing the ideation scenarios generated by ideation generator 104, ideation generator 104 presents such ideation scenarios in an order based on such a priority.

In one embodiment, ideation generator 104 is configured to identify ideation scenarios across industries and domains, such as ideation scenarios that within a threshold degree of similarity to the generated/presented ideation scenarios. A domain, as used herein, refers to a knowledge corpus corresponding to a collection of ideation scenarios based on intents across various businesses, industries, etc. In one embodiment, ideation generator 104 identifies such ideation scenarios across industries and domains by utilizing one or more of the intents from the generated/presented ideation scenarios as a search query. Upon identifying an ideation scenario in such an industry or domain that is within a threshold degree of similarity to a generated/presented ideation scenario, such identified ideation scenarios may then be presented to the user. In one embodiment, ideation generator 104 may further generate code, designs, and/or testing for such presented ideation scenarios.

In one embodiment, ideation generator 104 receives feedback from the user, such as the user (e.g., software developer) of computing device 101, regarding the presented ideation scenarios. Based on such feedback (e.g., the ideation scenario pertaining to presenting the option to a user of fetching a webpage upon logging into the system was deemed to be unsatisfactory by the evaluator), ideation generator 104 determines if the feedback received for the particular presented ideation scenario over a period of time from multiple users has been excessively negative. “Excessively negative,” as used herein, refers to a rating that is below a user-designated threshold.

In one embodiment, feedback from the user may be positive or negative, such as based on a rating. Upon receiving such feedback from the user, ideation generator 104 may reassess the value of the ideation scenario by determining if the feedback received over a period of time from multiple users has been excessively negative for such an ideation scenario. For instance, if the average of the ratings (e.g., ratings may range from 0 to 5, with 5 being the highest) has been less than a user-designated number (e.g., 2.2) over the past period of time (e.g., 1 month), which may be user-designated, then such an ideation scenario may be removed from storage, such as being deleted from database 105.

If such feedback pertaining to a particular presented ideation scenario has not been excessively negative, then ideation generator 104 continues to store and use the presented ideation scenario for future use.

If, however, such feedback pertaining to a particular presented ideation scenario has been excessively negative, then ideation generator 104 removes such an ideation scenario from storage (e.g., database 105) to prevent such ideation scenario from being used in the future. For example, based on such an excessively negative feedback, the presented ideation scenario (e.g., the ideation scenario pertaining to presenting the option to a user of fetching a webpage upon logging into the system was deemed to be unsatisfactory by the evaluator) is removed from storage (e.g., database 105) for future use.

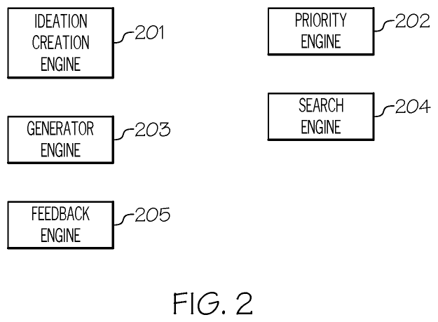

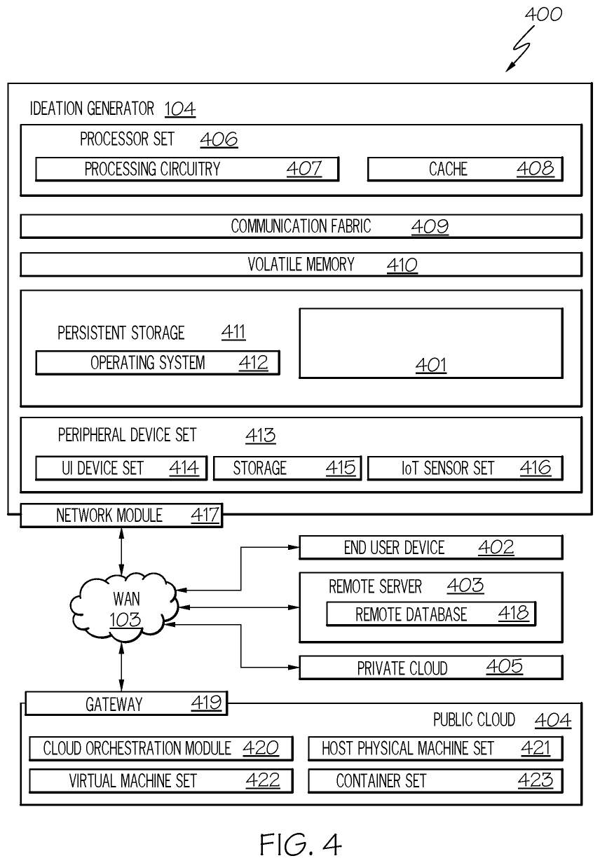

A description of the software components of ideation generator 104 used for generating ideation scenarios based on intents is provided below in connection with FIG. 2. A description of the hardware configuration of ideation generator 104 is provided further below in connection with FIG. 4.

System 100 is not to be limited in scope to any one particular network architecture. System 100 may include any number of computing devices 101, software development systems 102, networks 103, ideation generators 104, and databases 105.

A discussion regarding the software components used by ideation generator 104 to generate ideation scenarios based on intents is provided below in connection with FIG. 2.

FIG. 2 is a diagram of the software components used by ideation generator 104 (FIG. 1) to generate ideation scenarios based on intents in accordance with an embodiment of the present disclosure.

As shown in FIG. 2, ideation generator 104 includes an ideation creation engine 201 configured to generate ideations based on intents across different requirements.

In one embodiment, ideation creation engine 201 is configured to receive a requirement to be used in ideation. A requirement, as used herein, refers to a necessary condition that is required in the design, code, and/or test.

In one embodiment, ideation creation engine 201 receives a requirement to be used in ideation from a user (e.g., software developer) of computing device 101. In one embodiment, the user inputs the requirement via the graphical user interface of computing device 101, which is transmitted to ideation generator 104 via network 103.

For example, the user may request the requirement of having the user visit the dashboard webpage after logging into the system. Such a requirement is received by ideation creation engine 201 to be used in generating an ideation scenario. An ideation scenario, as used herein, refers to an idea or solution based on a requirement.

Furthermore, ideation creation engine 201 is configured to identify the intent associated with the received requirement. An intent, as used herein, refers to the actions to be performed to accomplish the purpose or objective of the requirement. In one embodiment, each intent is associated with a requirement as well as one or more inputs and a final output.

In one embodiment, a list of requirements is stored in database 105. In an alternative embodiment, such a list of requirements is stored in a data structure (e.g., table) that resides within the storage device of ideation generator 104. In one embodiment, each of the requirements in the list of requirements is associated with an intent, which is also stored in database 105 and/or the data structure (e.g., table) discussed above. In one embodiment, such a list of requirements and the associated intents are populated by an expert.

In one embodiment, upon receiving the requirement to be used in ideation, ideation creation engine 201 performs a look-up in database 105 and/or the data structure discussed above to identify such a requirement. Upon identifying such a requirement, the associated intent is then identified by ideation creation engine 201 in database 105 and/or the data structure discussed above.

For example, suppose that the requirement received from the user is to present a dashboard webpage after successfully logging into the system. Upon receiving such a requirement, ideation creation engine 201 performs a look-up in database 105 and/or the data structure discussed above to identify such a requirement in the list of requirements in database 105 and/or the data structure discussed above. Upon identifying such a requirement, ideation creation engine 201 identifies the intent associated with such a requirement. For example, for the requirement of presenting a dashboard webpage after successfully logging into the system, the intent of having the dashboard webpage be displayed after logging into the system (input) with no other additional input and the dashboard webpage corresponding to the final output is identified. As illustrated in this example, in one embodiment, the intent is associated with not only the requirement but also one or more inputs and a final output.

In one embodiment, ideation creation engine 201 is configured to identify a pre-requirement and a post-requirement to the received requirement from a list of requirements, which may be stored in database 105 and/or the data structure discussed above. A pre-requirement, as used herein, refers to the requirement that is listed prior to the received requirement in the list of requirements. A post-requirement, as used herein, refers to the requirement that is listed after the received requirement in the list of requirements.

In one embodiment, ideation creation engine 201 performs a look-up in database 105 and/or the data structure discussed above to identify the pre-requirement and the post-requirement with respect to the received requirement from the list of requirements stored in database 105 and/or the data structure discussed above.

Upon identifying such requirements (pre-requirement and post-requirement), ideation creation engine 201 identifies the intents associated with such requirements.

As discussed above, in one embodiment, the requirements in the list of requirements are logically connected in terms of the intents associated with such requirements. For example, the requirements listed prior and after the received requirement are all logically connected in terms of the intents associated with such requirements. For instance, such intents may be directed to actions to be performed to accomplish the purpose or objective of the requirements pertaining to user access of webpages.

In one embodiment, upon identifying such requirements (pre-requirement and post-requirement) in the list of requirements in database 105 and/or the data structure discussed above, ideation creation engine 201 identifies the intents associated with such requirements in database 105 and/or the data structure as discussed above.

For example, suppose the requirement received from the user (e.g., software developer) of computing device 101 is presenting a dashboard webpage after successfully logging into the system. Upon identifying such a requirement in the list of requirements in database 105 and/or the data structure discussed above, ideation creation engine 201 then identifies the pre-requirement and post-requirement corresponding to the requirements surrounding the received requirement identified in the list of requirements. For instance, the pre-requirement may be to have the user log into the system using his/her user identification and password. The post-requirement may be to display a webpage directed to triggering, monitoring, or cancelling jobs for further action after displaying the dashboard webpage.

Ideation creation engine 201 then identifies the intents for the pre-requirement and the post-requirement. In one embodiment, ideation creation engine 201 identifies such intents based on identifying the intents associated with such requirements (pre-requirement and post-requirement) from database 105 and/or the data structure discussed above. For example, ideation creation engine 201 may identify the intent associated with the pre-requirement (have the user log into the system using his/her user identification and password) from database 105 and/or the data structure discussed above as corresponding to having the correct set of user identification and password in order to allow the user to log into the system. Otherwise, the user will be prevented from logging into the system. Such an intent is also associated with one or more inputs (e.g., user identification, password) and a final output (e.g., logging into the system). In another example, ideation creation engine 201 may identify the intent associated with the post-requirement (display a webpage directed to triggering, monitoring, or cancelling jobs for further action after displaying the dashboard webpage) from database 105 and/or the data structure discussed above as corresponding to having additional inputs of choosing a webpage to be fetched with a unitary action, where the final output is the user-selected webpage.

Upon identifying such intents, such as for the received requirement and the pre- and post-requirements, such intents may be joined to generate ideation scenarios based on such joined intents. An ideation scenario, as used herein, refers to the idea or solution based on a requirement. In one embodiment, such ideation scenarios include the intents along with the associated requirements, one or more inputs and final output.

In one embodiment, ideation creation engine 201 performs an analysis on the joined intents to identify ideation scenarios. In one embodiment, such ideation scenarios correspond to different combinations of intents. For example, suppose that intent #1 is associated with the pre-requirement, intent #2 is associated with the received requirement and intent #3 is associated with the post-requirement. Ideation scenarios may include the combination of intents #1, #2 and #3 in such an order, the combination of intents #1 and #3 in such an order, the combination of intents #2 and #3 in such an order and so forth.

In another embodiment, such ideation scenarios correspond to a subset of the actions in different combinations of intents. For example, an ideation scenario may include the combination of action #1 from intent #1 and action #2 from intent #3.

In one embodiment, the combination of intents or the combination of the subset of the actions from different intents may be established based on the strength of correlations between the intents or between the subset of the actions in the intents. In one embodiment, such strength may be determined by vectorizing the intents or the subset of the actions in the intents, such as via Word2vec, Doc2Vec, GloVe, etc. After being converted into real-valued vectors, a similarity measure, such as cosine similarity or the Euclidean distance, may be used to determine the similarity between the two intents or the subset of the actions in the intents.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then ideation creation engine 201 may select such intents or the subset of the actions in the intents to be used in an ideation scenario.

In one embodiment, the Euclidean distance is calculated as the square root of the sum of the squared differences between the two feature vectors. If the distance exceeds a threshold value, which may be user-designated, then ideation creation engine 201 may select such intents or the subset of the actions in the intents to be used in an ideation scenario.

In one embodiment, the similarity measure is a score between the values of 0 and 1 for vectors that have only positive values. In one embodiment, any negative scores can be made positive by taking its absolute value.

Ideation creation engine 201 utilizes various software tools for generating the similarity score, which can include, but are not limited to, TensorFlow®, MathWorks®, plus sklearn, scikit-Learn®, etc.

Examples of ideation scenarios generated by ideation creation engine 201 using the example above include the ideation scenario of having the user provide correct credentials to log into the system, followed by presenting the dashboard webpage upon the user successfully logging into the system, and followed by having additional inputs of choosing a webpage to be fetched with a unitary action, where the final output is the user-selected webpage. In another example, the ideation scenario may correspond to having the user provide correct credentials to log into the system, followed by presenting the user an option to choose a webpage to be fetched with a unitary action, where the final output is the user-selected webpage.

Ideation generator 104 further includes a priority engine 202 configured to prioritize the generated ideation scenarios. In one embodiment, priority engine 202 prioritizes the generated ideation scenarios based on the weight assigned to each of the requirements (e.g., requirement received from the user, pre-requirement, post-requirement) corresponding to a level of priority. In one embodiment, such weights are provided by a user, such as a user (e.g., software developer) of computing device 101.

In one embodiment, priority engine 202 generates a score for each of the generated ideation scenarios based on the weight assigned to each of the requirements corresponding to a level of priority. In one embodiment, the weights assigned to the requirements add up to a value of 1. For example, the score (S) for the generated ideation scenario (I) for requirement R with weightage W corresponds to the following formula:

S=Σ₁ⁿRW

were n is a positive integer number, representing the number of requirements.

For example, I corresponds to the ideation scenario of logging into a portal. Requirement #1 corresponds to security with a weightage of 0.7 and requirement #2 corresponds to usability with the weightage of 0.3.

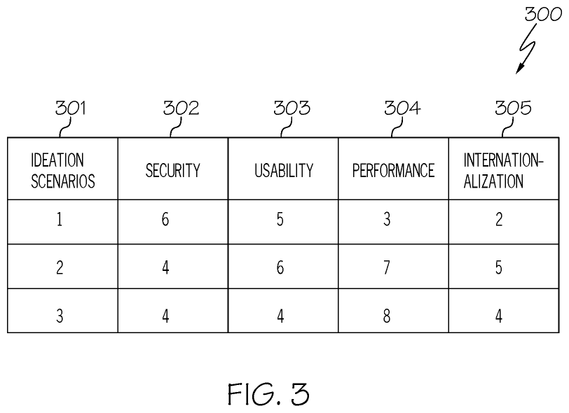

Referring now to FIG. 3, FIG. 3 is a table 300 illustrating the requirements for different generated ideation scenarios as well as the scores assigned to such requirements in how well such requirements are met by the generated ideation scenarios in accordance with an embodiment of the present disclosure.

As shown in FIG. 3, table 300 includes a column 301 identifying the particular ideation scenario (e.g., 1, 2 and 3) as well as columns 302-305 identifying the various requirements (e.g., security, usability, performance and internationalization) along with a score (e.g., range from 0 to 10) indicating how well the requirement is met by such a generated ideation scenario. In one embodiment, such a score has a range between 0 and 10, where the higher the value, the greater the requirement is met by the generated ideation scenario. In one embodiment, such a table (e.g., table 300) resides within the storage device of ideation generator 104. In one embodiment, such a table (e.g., table 300) is populated by an expert, including establishing the scores indicating how well the requirement is met by such a generated ideation scenario.

In one embodiment, the weightings discussed above may be applied to such scores for the requirements to determine the score for the generated ideation scenario.

For instance, referring to ideation scenario #1 in table 300 (S1), the score for such an ideation scenario using the weightage of 0.7 for security and the weightage of 0.3 for usability results in a score of 5.7 (S1=6*0.7+5*0.3). Similarly, the score for ideation scenario #2 in table 300 (S2) is 4.6 (S2=4*0.7+6*0.3). In another example, the score for ideation scenario #3 in table 300 (S3) is 4.0 (S3=4*0.7+4*0.3).

In one embodiment, the ideation scenarios may be prioritized based on such scores, where the ideation scenarios with a higher score have a higher priority than those ideation scenarios with a lower score.

In one embodiment, ideation creation engine 201 may then present such prioritized ideation scenarios to the user (e.g., user of computing device 101) in the order of priority. Alternatively, ideation creation engine 201 may simply present the generated ideation scenarios to the user (e.g., user of computing device 101) without prioritizing such ideation scenarios.

Furthermore, ideation generator 104 includes a generator engine 203 configured to generate code, designs and/or testing for the presented ideation scenarios.

In one embodiment, generator engine 203 generates code based on a presented ideation scenario by using a template that enables a code generation tool to automatically generate code, such as for ideation scenarios. Examples of such software tools can include, but are not limited to, CodeSmith Generator, Aicodoo, Celerio®, AtomWeaver, Acceleo®, etc.

In one embodiment, generator engine 203 generates designs based on a presented ideation scenario based on categorizing the presented ideation scenarios, such as based on the intents of the presented ideation scenarios, into classifications, such as the purpose or objective of the intent. Based on such classification, the classification may be associated with a design, which can be automatically generated using various software tools, which can include, but are not limited to, Axure®, Figma®, MockFlow®, etc.

In one embodiment, generator engine 203 generates tests based on a presented ideation scenario based on categorizing the presented ideation scenarios, such as based on the intents of the presented ideation scenarios, into classifications, such as the purpose or objective of the intent. Based on such classification, the classification may be associated with a test, which can be automatically generated using various software tools, which can include, but are not limited to, TestRail®, Testmo®, SpiraTest®, etc.

Furthermore, ideation generator 104 includes a search engine 204 configured to identify ideation scenarios across industries and domains that are similar to the presented ideation scenarios. A domain, as used herein, refers to a knowledge corpus corresponding to a collection of ideation scenarios based on intents across various businesses, industries, etc. In one embodiment, ideation scenarios across industries and domains are stored in a database, such as database 105.

In one embodiment, search engine 204 uses one or more intents from the presented ideation scenarios as a search query. In one embodiment, such a search query is used for searching for ideation scenarios across industries and domains, such as those ideation scenarios stored in database 105, that are within a threshold degree of similarity, which may be user-designated, to the presented ideation scenarios based on the intents of the search query.

In one embodiment, the threshold degree of similarity between ideation scenarios (between the ideation scenarios that were presented and those that were used across industries and domains) is determined based on the similarity between the intents of the ideation scenarios or between the subset of the actions in the intents of the ideation scenarios. In one embodiment, such similarity may be determined by vectorizing the intents or the subset of the actions in the intents, such as via Word2vec, Doc2Vec, GloVe, etc. After being converted into real-valued vectors, a similarity measure, such as cosine similarity or the Euclidean distance, may be used to determine the similarity between the two intents or the subset of the actions in the intents. Such a similarity measure may then be compared to a threshold value, which may be user-designated, to determine if the ideation scenario across industries and domains is within a threshold degree of similarity to the presented ideation scenario (i.e., within a threshold degree of similarity to the intent(s) of the search query). If such a measure exceeds such a threshold value, then the ideation scenario across industries and domains is selected to be presented to the user as a similar ideation scenario to a presented ideation scenario. If, however, such a measure does not exceed such a threshold value, then the ideation scenario across industries and domains is not selected to be presented to the user as a similar ideation scenario to a presented ideation scenario.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then search engine 204 may select such an ideation scenario across industries and domains, such as an ideation scenario stored in database 105, to be presented to the user (e.g., user of computing device 101) as an ideation scenario that is similar to a presented ideation scenario.

In one embodiment, the Euclidean distance is calculated as the square root of the sum of the squared differences between the two feature vectors. If the distance exceeds a threshold value, which may be user-designated, then search engine 204 may select such an ideation scenario across industries and domains, such as an ideation scenario stored in database 105, to be presented to the user (e.g., user of computing device 101) as an ideation scenario that is similar to a presented ideation scenario.

In one embodiment, the similarity measure is a score between the values of 0 and 1 for vectors that have only positive values. In one embodiment, any negative scores can be made positive by taking its absolute value.

In one embodiment, if search engine 204 cannot identify any ideation scenarios that are similar within a threshold degree of similarity to a presented ideation scenario, then such presented ideation scenario (i.e., the intents of the presented ideation scenario used as a search query) is identified as being new. In one embodiment, such new ideation scenarios may be stored in database 105 for future use. For example, such an ideation scenario may be fetched from database 105 by ideation creation engine 201 to be presented to the user based on receiving the requirement associated with such an ideation scenario from the user.

In one embedment, search engine 204 utilizes various software tools for generating the similarity score, which can include, but are not limited to, TensorFlow®, MathWorks®, plus sklearn, scikit-Learn®, etc.

Additionally, ideation generator 104 includes a feedback engine 205 configured to receive feedback from the user, such as the user (e.g., software developer) of computing device 101, regarding the presented ideation scenarios. Based on such feedback (e.g., the ideation scenario pertaining to presenting the option to a user of fetching a webpage upon logging into the system was deemed to be unsatisfactory by the evaluator), the ideation scenario may no longer be stored, such as in database 105, for future use.

In one embodiment, such feedback is provided by the user, such as user of computing device 101, via the graphical user interface of computing device 101. In one embodiment, such feedback is provided by the user via email messages or text messages.

In one embodiment, feedback from the user may be positive or negative, such as based on a rating. Upon receiving such feedback from the user, feedback engine 205 may reassess the value of the ideation scenario by determining if the feedback received over a period of time from multiple users has been excessively negative for such an ideation scenario. For instance, if the average of the ratings (e.g., e.g., ratings may range from 0 to 5, with 5 being the highest) has been less than a user-designated number (e.g., 2.2) over the past period of time (e.g., 1 month), which may be user-designated, then such an ideation scenario may be removed from storage, such as being deleted from database 105.

A further description of these and other features is provided below in connection with the discussion of the method for generating ideation scenarios based on intents associated with requirements.

Prior to the discussion of the method for generating ideation scenarios based on intents associated with requirements, a description of the hardware configuration of ideation generator 104 (FIG. 1) is provided below in connection with FIG. 4.

Referring now to FIG. 4, in conjunction with FIG. 1, FIG. 4 illustrates an embodiment of the present disclosure of the hardware configuration of ideation generator 104 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code (computer code for generating ideation scenarios based on intents associated with requirements, which is stored in block 401) involved in performing the disclosed methods, such as generating ideation scenarios based on intents associated with requirements. In addition to block 401, computing environment 400 includes, for example, ideation generator 104, network 103, such as a wide area network (WAN), end user device (EUD) 402, remote server 403, public cloud 404, and private cloud 405. In this embodiment, ideation generator 104 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Ideation generator 104 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically ideation generator 104, to keep the presentation as simple as possible. Ideation generator 104 may be located in a cloud, even though it is not shown in a cloud in FIG. 4. On the other hand, ideation generator 104 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto ideation generator 104 to cause a series of operational steps to be performed by processor set 406 of ideation generator 104 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 408 and the other storage media discussed below. The program instructions, and associated data, are accessed by processor set 406 to control and direct performance of the disclosed methods. In computing environment 400, at least some of the instructions for performing the disclosed methods may be stored in block 401 in persistent storage 411.

Communication fabric 409 is the signal conduction paths that allow the various components of ideation generator 104 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In ideation generator 104, the volatile memory 410 is located in a single package and is internal to ideation generator 104, but, alternatively or additionally, the volatile memory may be distributed over multiple packages and/or located externally with respect to ideation generator 104.

Persistent Storage 411 is any form of non-volatile storage for computers that is now known or to be developed in the future. The non-volatility of this storage means that the stored data is maintained regardless of whether power is being supplied to ideation generator 104 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the disclosed methods.

Peripheral device set 413 includes the set of peripheral devices of ideation generator 104. Data communication connections between the peripheral devices and the other components of ideation generator 104 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where ideation generator 104 is required to have a large amount of storage (for example, where ideation generator 104 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows ideation generator 104 to communicate with other computers through WAN 103. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the disclosed methods can typically be downloaded to ideation generator 104 from an external computer or external storage device through a network adapter card or network interface included in network module 417.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates ideation generator 104), and may take any of the forms discussed above in connection with ideation generator 104. EUD 402 typically receives helpful and useful data from the operations of ideation generator 104. For example, in a hypothetical case where ideation generator 104 is designed to provide a recommendation to an end user, this recommendation would typically be communicated from network module 417 of ideation generator 104 through WAN 103 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to ideation generator 104. Remote server 403 may be controlled and used by the same entity that operates ideation generator 104. Remote server 403 represents the machine(s) that collect and store helpful and useful data for use by other computers, such as ideation generator 104. For example, in a hypothetical case where ideation generator 104 is designed and programmed to provide a recommendation based on historical data, then this historical data may be provided to ideation generator 104 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to generate ideation scenarios based on intents associated with requirements. In one embodiment, such components may be implemented in hardware. The functions discussed above performed by such components are not generic computer functions. As a result, ideation generator 104 is a particular machine that is the result of implementing specific, non-generic computer functions.

In one embodiment, the functionality of such software components of ideation generator 104, including the functionality for generating ideation scenarios based on intents associated with requirements, may be embodied in an application specific integrated circuit.

As stated above, various software tools, such as software development tools, have been developed to assist the user in software development. For example, such software tools may help software developers create, debug, maintain, or otherwise support other programs and applications. Examples of such software development tools include a source code editor and a compiler or interpreter, which are used ubiquitously and continuously. Other software development tools are used more or less depending on the language, development methodology, and individual engineer, often used for a discrete task, such as a debugger or profiler. Software development tools may be discrete programs, executed separately—often from the command line—or may be parts of a single large program, called an integrated development environment (IDE). Furthermore, such software development tools assist the software developer in designing, coding and testing, such as from the requirements inputted by the software developer. Designing refers to the process in creating digital designs for a variety of purposes. Coding refers to creating the programming code which provides instructions to a computing device to perform certain actions. Testing refers to the process of evaluating and verifying that a software or application does what it is supposed to do. While such software development tools assist the software developer in designing, coding, and testing, such software development tools do not assist the software developer in ideating (generating ideas) or generating such designs, code, and tests based on such ideations. Ideation is the process of generating ideas and solutions. By not generating such ideations or taking into consideration such ideations, the assistance provided by the software development tool in designing, coding, and testing is limited. As a result, such software development tools are deficient in assisting users, such as software developers, in designing, coding, and testing by not ideating or generating designs, code, and tests based on such ideations.

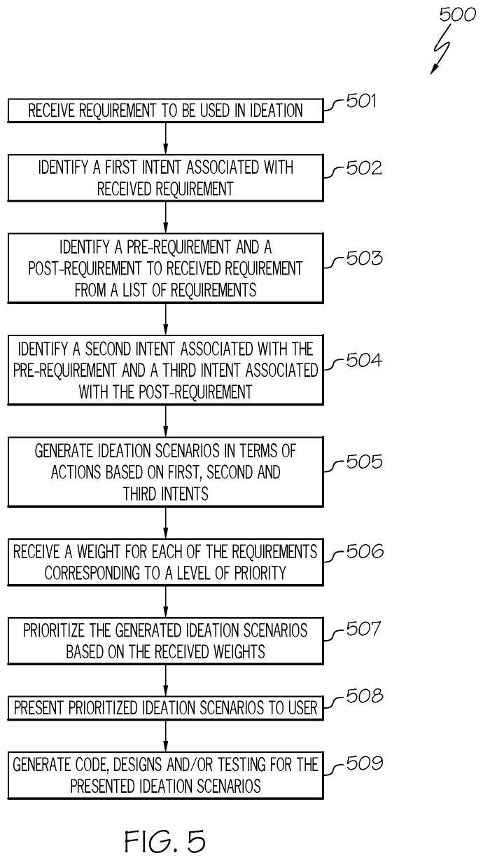

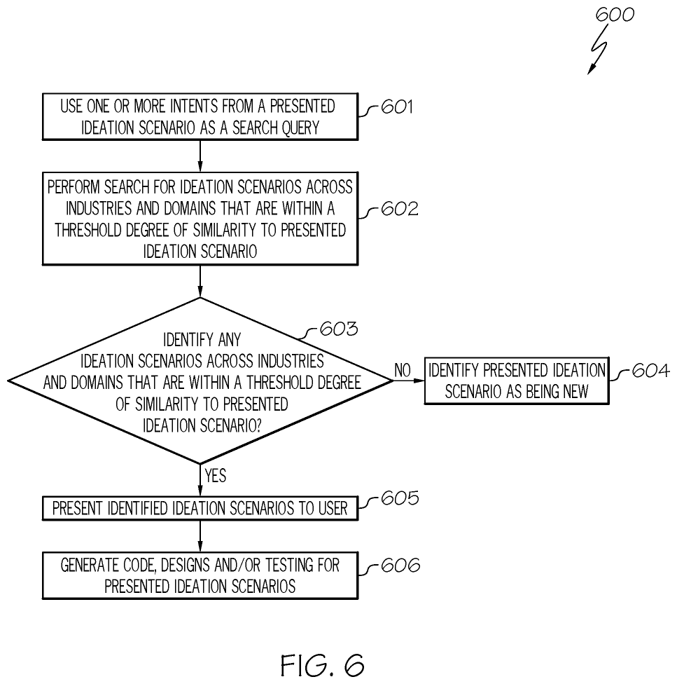

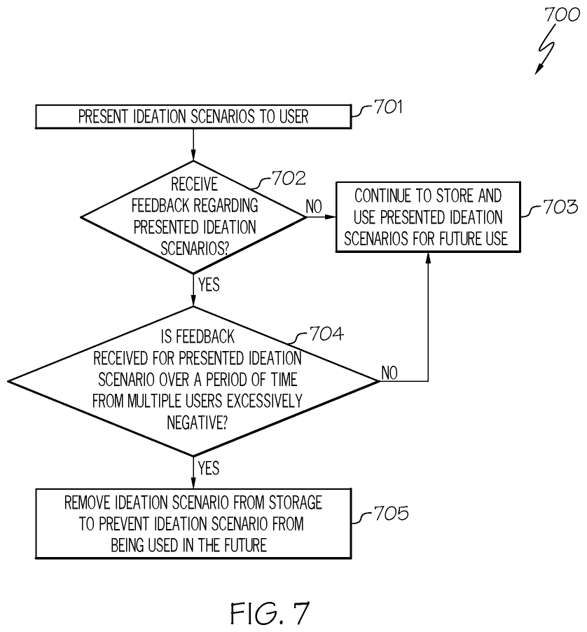

The embodiments of the present disclosure provide a means for generating ideations as well as generating designs, code, and tests based on such ideations as discussed below in connection with FIGS. 5-7. FIG. 5 is a flowchart of a method for generating ideations based on intents associated with requirements. FIG. 6 is a flowchart of a method for identifying relevant ideation scenarios across industries and domains. FIG. 7 is a flowchart of a method for handling feedback regarding the presented ideation scenarios.

As stated above, FIG. 5 is a flowchart of a method 500 for generating ideations based on intents associated with requirements in accordance with an embodiment of the present disclosure.

Referring to FIG. 5, in conjunction with FIGS. 1-4, in step 501, ideation creation engine 201 of ideation generator 104 receives a requirement to be used in ideation. A requirement, as used herein, refers to a necessary condition that is required in the design, code, and/or test.

As discussed above, in one embodiment, ideation creation engine 201 receives a requirement to be used in ideation from a user (e.g., software developer) of computing device 101. In one embodiment, the user inputs the requirement via the graphical user interface of computing device 101, which is transmitted to ideation generator 104 via network 103.

For example, the user may request the requirement of having the user visit the dashboard webpage after logging into the system. Such a requirement is received by ideation creation engine 201 to be used in generating an ideation scenario. An ideation scenario, as used herein, refers to an idea or solution based on a requirement.

In step 502, ideation creation engine 201 of ideation generator 104 identifies the intent associated with the received requirement. An intent, as used herein, refers to the actions to be performed to accomplish the purpose or objective of the requirement. In one embodiment, each intent is associated with a requirement as well as one or more inputs and a final output.

As stated above, in one embodiment, a list of requirements is stored in database 105. In an alternative embodiment, such a list of requirements is stored in a data structure (e.g., table) that resides within the storage device (e.g., storage device 411, 415) of ideation generator 104. In one embodiment, each of the requirements in the list of requirements is associated with an intent, which is also stored in database 105 and/or the data structure (e.g., table) discussed above. In one embodiment, such a list of requirements and the associated intents are populated by an expert.

In one embodiment, upon receiving the requirement to be used in ideation, ideation creation engine 201 performs a look-up in database 105 and/or the data structure discussed above to identify such a requirement. Upon identifying such a requirement, the associated intent is then identified by ideation creation engine 201 in database 105 and/or the data structure discussed above.

For example, suppose that the requirement received from the user is to present a dashboard webpage after successfully logging into the system. Upon receiving such a requirement, ideation creation engine 201 performs a look-up in database 105 and/or the data structure discussed above to identify such a requirement in the list of requirements in database 105 and/or the data structure discussed above. Upon identifying such a requirement, ideation creation engine 201 identifies the intent associated with such a requirement. For example, for the requirement of presenting a dashboard webpage after successfully logging into the system, the intent of having the dashboard webpage be displayed after logging into the system with no additional input and the dashboard webpage corresponding to the final output is identified. As illustrated in this example, in one embodiment, the intent is associated with not only the requirement but also one or more inputs and a final output.

In step 503, ideation creation engine 201 of ideation generator 104 identifies a pre-requirement and a post-requirement to the received requirement from a list of requirements, which may be stored in database 105 and/or the data structure discussed above. A pre-requirement, as used herein, refers to the requirement that is listed prior to the received requirement in the list of requirements. A post-requirement, as used herein, refers to the requirement that is listed after the received requirement in the list of requirements.

As discussed above, in one embodiment, ideation creation engine 201 performs a look-up in database 105 and/or the data structure discussed above to identify the pre-requirement and the post-requirement with respect to the received requirement from the list of requirements stored in database 105 and/or the data structure discussed above.

In step 504, upon identifying such requirements (pre-requirement and post-requirement), ideation creation engine 201 of ideation generator 104 identifies the intents associated with such requirements.

As discussed above, in one embodiment, the requirements in the list of requirements are logically connected in terms of the intents associated with such requirements. For example, the requirements listed prior and after the received requirement are all logically connected in terms of the intents associated with such requirements. For instance, such intents may be directed to actions to be performed to accomplish the purpose or objective of the requirements pertaining to user access of webpages.

In one embodiment, upon identifying such requirements (pre-requirement and post-requirement) in the list of requirements in database 105 and/or the data structure discussed above, ideation creation engine 201 identifies the intents associated with the requirements in database 105 and/or the data structure discussed above.

For example, suppose the requirement received from the user (e.g., software developer) of computing device 101 is presenting a dashboard webpage after successfully logging into the system. Upon identifying such a requirement in the list of requirements in database 105 and/or the data structure discussed above, ideation creation engine 201 then identifies the pre-requirement and post-requirement corresponding to the requirements surrounding the received requirement identified in the list of requirements. For instance, the pre-requirement may be to have the user log into the system using his/her user identification and password. The post-requirement may be to display a webpage directed to triggering, monitoring, or cancelling jobs for further action after displaying the dashboard webpage.

In one embodiment, ideation creation engine 201 identifies the intents for the pre-requirement and the post-requirement. In one embodiment, ideation creation engine 201 identifies such intents based on identifying the intents associated with such requirements (pre-requirement and post-requirement) from database 105 and/or the data structure discussed above. For example, ideation creation engine 201 may identify the intent associated with the pre-requirement (have the user log into the system using his/her user identification and password) from database 105 and/or the data structure discussed above as corresponding to having the correct set of user identification and password in order to allow the user to log into the system. Otherwise, the user will be prevented from logging into the system. Such an intent is also associated with one or more inputs (e.g., user identification, password) and a final output (e.g., logging into the system). In another example, ideation creation engine 201 may identify the intent associated with the post-requirement (display a webpage directed to triggering, monitoring, or cancelling jobs for further action after displaying the dashboard webpage) from database 105 and/or the data structure discussed above as corresponding to having additional inputs of choosing a webpage to be fetched with a unitary action, where the final output is the user-selected webpage.

In step 505, upon identifying such intents, such as for the received requirement and the pre- and post-requirements, ideation creation engine 201 of ideation generator 104 joins such intents to generate ideation scenarios in terms of actions based on such joined intents. An ideation scenario, as used herein, refers to the idea or solution based on a requirement. In one embodiment, such ideation scenarios include the intents along with the associated requirements, one or more inputs and final output.

As stated above, in one embodiment, ideation creation engine 201 performs an analysis on the joined intents to identify ideation scenarios. In one embodiment, such ideation scenarios correspond to different combinations of intents. For example, suppose that intent #1 is associated with the pre-requirement, intent #2 is associated with the received requirement and intent #3 is associated with the post-requirement. Ideation scenarios may include the combination of intents #1, #2 and #3 in such an order, the combination of intents #1 and #3 in such an order, the combination of intents #2 and #3 in such an order and so forth.

In another embodiment, such ideation scenarios correspond to a subset of the actions in different combinations of intents. For example, an ideation scenario may include the combination of action #1 from intent #1 and action #2 from intent #3.

In one embodiment, the combination of intents or the combination of the subset of the actions from different intents may be established based on the strength of correlations between the intents or between the subset of the actions in the intents. In one embodiment, such strength may be determined by vectorizing the intents or the subset of the actions in the intents, such as via Word2vec, Doc2Vec, GloVe, etc. After being converted into real-valued vectors, a similarity measure, such as cosine similarity or the Euclidean distance, may be used to determine the similarity between the two intents or the subset of the actions in the intents.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then ideation creation engine 201 may select such intents or the subset of the actions in the intents to be used in an ideation scenario.

In one embodiment, the Euclidean distance is calculated as the square root of the sum of the squared differences between the two feature vectors. If the distance exceeds a threshold value, which may be user-designated, then ideation creation engine 201 may select such intents or the subset of the actions in the intents to be used in an ideation scenario.

In one embodiment, the similarity measure is a score between the values of 0 and 1 for vectors that have only positive values. In one embodiment, any negative scores can be made positive by taking its absolute value.

Ideation creation engine 201 utilizes various software tools for generating the similarity score, which can include, but are not limited to, TensorFlow®, MathWorks®, plus sklearn, scikit-Learn®, etc.

Examples of ideation scenarios generated by ideation creation engine 201 using the example above include the ideation scenario of having the user provide correct credentials to log into the system, followed by presenting the dashboard webpage upon the user successfully logging into the system, and followed by having additional inputs of choosing a webpage to be fetched with a unitary action, where the final output is the user-selected webpage. In another example, the ideation scenario may correspond to having the user provide correct credentials to log into the system, followed by presenting the user an option to choose a webpage to be fetched with a unitary action, where the final output is the user-selected webpage.

In step 506, priority engine 202 of ideation generator 104 receives a weight assigned to each of the requirements (e.g., requirement received from the user, pre-requirement, post-requirement) corresponding to a level of priority. In one embodiment, such weights are provided by a user, such as a user (e.g., software developer) of computing device 101.

In step 507, priority engine 202 of ideation generator 104 prioritizes the generated ideation scenarios based on the received weights.

As discussed above, in one embodiment, priority engine 202 generates a score for each of the generated ideation scenarios based on the weight assigned to each of the requirements corresponding to a level of priority. In one embodiment, the weights assigned to the requirements add up to a value of 1. For example, the score (S) for the generated ideation scenario (I) for requirement R with weightage W corresponds to the following formula:

S=Σ₁ⁿRW

were n is a positive integer number, representing the number of requirements.

For example, I corresponds to the ideation scenario of logging into a portal. Requirement #1 corresponds to security with a weightage of 0.7 and requirement #2 corresponds to usability with the weightage of 0.3.

An example illustrating the requirements for different generated ideation scenarios as well as the scores assigned to such requirements in how well such requirements are met by the generated ideation scenarios is provided in FIG. 3.

Referring to FIG. 3, table 300 includes a column 301 identifying the particular ideation scenario (e.g., 1, 2 and 3) as well as columns 302-305 identifying the various requirements (e.g., security, usability, performance and internationalization) along with a score (e.g., range from 0 to 10) indicating how well the requirement is met by such a generated ideation scenario. In one embodiment, such a score has a range between 0 and 10, where the higher the value, the greater the requirement is met by the generated ideation scenario. In one embodiment, such a table (e.g., table 300) resides within the storage device (e.g., storage device 411, 415) of ideation generator 104. In one embodiment, such a table (e.g., table 300) is populated by an expert, including establishing the scores indicating how well the requirement is met by such a generated ideation scenario.

In one embodiment, the weightings discussed above may be applied to such scores for the requirements to determine the score for the generated ideation scenario.

For instance, referring to ideation scenario #1 in table 300 (S1), the score for such an ideation scenario using the weightage of 0.7 for security and the weightage of 0.3 for usability results in a score of 5.7 (S1=6*0.7+5*0.3). Similarly, the score for ideation scenario #2 in table 300 (S2) is 4.6 (S2=4*0.7+6*0.3). In another example, the score for ideation scenario #3 in table 300 (S3) is 4.0 (S3=4*0.7+4*0.3).

In one embodiment, the ideation scenarios may be prioritized based on such scores, where the ideation scenarios with a higher score have a higher priority than those ideation scenarios with a lower score.

In step 508, ideation creation engine 201 of ideation generator 104 presents such prioritized ideation scenarios to the user (e.g., user of computing device 101) in the order of priority. Alternatively, ideation creation engine 201 may simply present the generated ideation scenarios to the user (e.g., user of computing device 101) without prioritizing such ideation scenarios, such as the ideation scenarios that were generated in step 505.

In step 509, generator engine 203 of ideation generator 104 generates code, designs and/or testing for the presented ideation scenarios.

As stated above, in one embodiment, generator engine 203 generates code based on a presented ideation scenario by using a template that enables a code generation tool to automatically generate code, such as for ideation scenarios. Examples of such software tools can include, but are not limited to, CodeSmith Generator, Aicodoo, Celerio®, AtomWeaver, Acceleo®, etc.

In one embodiment, generator engine 203 generates designs based on a presented ideation scenario based on categorizing the presented ideation scenarios, such as based on the intents of the presented ideation scenarios, into classifications, such as the purpose or objective of the intent. Based on such classification, the classification may be associated with a design, which can be automatically generated using various software tools, which can include, but are not limited to, Axure®, Figma®, MockFlow®, etc.

In one embodiment, generator engine 203 generates tests based on a presented ideation scenario based on categorizing the presented ideation scenarios, such as based on the intents of the presented ideation scenarios, into classifications, such as the purpose or objective of the intent. Based on such classification, the classification may be associated with a test, which can be automatically generated using various software tools, which can include, but are not limited to, TestRail®, Testmo®, SpiraTest®, etc.

Furthermore, relevant ideation scenarios across industries and domains can be identified as discussed below in connection with FIG. 6. A domain, as used herein, refers to a knowledge corpus corresponding to a collection of ideation scenarios based on intents across various businesses, industries, etc. In one embodiment, ideation scenarios across industries and domains are stored in a database, such as database 105.

FIG. 6 is a flowchart of a method 600 for identifying relevant ideation scenarios across industries and domains in accordance with an embodiment of the present disclosure.

Referring to FIG. 6, in conjunction with FIGS. 1-5, in step 601, search engine 204 of ideation generator 104 uses one or more intents from a presented ideation scenario (see step 508 of FIG. 5) as a search query.

In step 602, search engine 204 of ideation generator 104 performs a search for ideation scenarios across industries and domains, such as those ideation scenarios stored in database 105, that are within a threshold degree of similarity, which may be user-designated, to a presented ideation scenario based on the intents of the search query.

In step 603, search engine 204 of ideation generator 104 determines if any ideation scenarios across industries and domains are identified that are within a threshold degree of similarity to a presented ideation scenario.

As discussed above, in one embodiment, the threshold degree of similarity between ideation scenarios (between the ideation scenarios that were presented and those that were used across industries and domains) is determined based on the similarity between the intents of the ideation scenarios or between the subset of the actions in the intents of the ideation scenarios. In one embodiment, such similarity may be determined by vectorizing the intents or the subset of the actions in the intents, such as via Word2vec, Doc2Vec, GloVe, etc. After being converted into real-valued vectors, a similarity measure, such as cosine similarity or the Euclidean distance, may be used to determine the similarity between the two intents or the subset of the actions in the intents. Such a similarity measure may then be compared to a threshold value, which may be user-designated, to determine if the ideation scenario across industries and domains is within a threshold degree of similarity to the presented ideation scenario (i.e., within a threshold degree of similarity to the intent(s) of the search query). If such a measure exceeds such a threshold value, then the ideation scenario across industries and domains is selected to be presented to the user as a similar ideation scenario to a presented ideation scenario. If, however, such a measure does not exceed such a threshold value, then the ideation scenario across industries and domains is not selected to be presented to the user as a similar ideation scenario to a presented ideation scenario.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement exceeds a threshold value, which may be user-designated, then search engine 204 may select such an ideation scenario across industries and domains, such as an ideation scenario stored in database 105, to be presented to the user (e.g., user of computing device 101) as an ideation scenario that is similar to a presented ideation scenario.

In one embodiment, the Euclidean distance is calculated as the square root of the sum of the squared differences between the two feature vectors. If the distance exceeds a threshold value, which may be user-designated, then search engine 204 may select such an ideation scenario across industries and domains, such as an ideation scenario stored in database 105, to be presented to the user (e.g., user of computing device 101) as an ideation scenario that is similar to a presented ideation scenario.

In one embodiment, the similarity measure is a score between the values of 0 and 1 for vectors that have only positive values. In one embodiment, any negative scores can be made positive by taking its absolute value.

In one embedment, search engine 204 utilizes various software tools for generating the similarity score, which can include, but are not limited to, TensorFlow®, MathWorks®, plus sklearn, scikit-Learn®, etc.

If search engine 204 of ideation generator 104 cannot identify any ideation scenarios across industries and domains that are within a threshold degree of similarity to a presented ideation scenario, then, in step 604, search engine 204 of ideation generator 104 identifies such a presented ideation scenario (i.e., the intents of the presented ideation scenario used as a search query) as being new. In one embodiment, such new ideation scenarios may be stored in database 105 for future use. For example, such an ideation scenario may be fetched from database 105 by ideation creation engine 201 to be presented to the user based on receiving the requirement associated with such an ideation scenario from the user.

If, however, search engine 204 of ideation generator 104 identifies ideation scenarios across industries and domains that are within a threshold degree of similarity to a presented ideation scenario, then, in step 605, search engine 204 of ideation generator 104 presents such identified ideations scenarios to the user (e.g., user of computing device 101).

In step 606, generator engine 203 of ideation generator 104 generates code, designs and/or testing for the presented ideation scenarios (those presented in step 605) as discussed above in connection with step 509.

A discussion regarding handling feedback regarding the presented ideation scenarios is now provided below in connection with FIG. 7.

FIG. 7 is a flowchart of a method 700 for handling feedback regarding the presented ideation scenarios in accordance with an embodiment of the present disclosure.

Referring to FIG. 7, in conjunction with FIGS. 1-6, in step 701, ideation scenarios are presented to the user, such as discussed above in connection with step 508 of FIG. 5 and step 605 of FIG. 6. In one embodiment, the user (user who is presented the ideation scenarios) is provided an option to provide feedback regarding the presented ideation scenarios. In one embodiment, feedback may be provided by the user via the graphical user interface of computing device 101. In one embodiment, such feedback may be provided by the user via email messages or text messages.

In step 702, feedback engine 205 of ideation generator 104 determines if feedback is received, such as from the user (e.g., user of computing device 101), regarding the presented ideation scenarios.

If feedback has not been received regarding the presented ideation scenarios, then, in step 703, ideation generator 104 continues to store and use the presented ideation scenarios for future use.

If, however, feedback has been received for a particular presented ideation scenario, then, in step 704, feedback engine 205 of ideation generator 104 determines if the feedback received for the particular presented ideation scenario over a period of time from multiple users has been excessively negative. “Excessively negative,” as used herein, refers to a rating that is below a user-designated threshold.

As discussed above, in one embodiment, feedback from the user may be positive or negative, such as based on a rating. Upon receiving such feedback from the user, feedback engine 205 may reassess the value of the ideation scenario by determining if the feedback received over a period of time from multiple users has been excessively negative for such an ideation scenario. For instance, if the average of the ratings (e.g., e.g., ratings may range from 0 to 5, with 5 being the highest) has been less than a user-designated number (e.g., 2.2) over the past period of time (e.g., 1 month), which may be user-designated, then such an ideation scenario may be removed from storage, such as being deleted from database 105.

If such feedback pertaining to a particular presented ideation scenario has not been excessively negative, then ideation generator 104 continues to store and use the presented ideation scenario for future use in step 703.

If, however, such feedback pertaining to a particular presented ideation scenario has been excessively negative, then, in step 705, feedback engine 205 of ideation generator 104 removes such an ideation scenario from storage (e.g., database 105) to prevent such an ideation scenario from being used in the future. For example, based on such an excessively negative feedback, the presented ideation scenario (e.g., the ideation scenario pertaining to presenting the option to a user of fetching a webpage upon logging into the system was deemed to be unsatisfactory by the evaluator) is removed from storage (e.g., database 105) for future use.

In this manner, the deficiency in software development tools is overcome by generating ideas as well as generating designs, code, and tests based on such ideations.

Furthermore, the principles of the present disclosure improve the technology or technical field involving software development tools.

As discussed above, various software tools, such as software development tools, have been developed to assist the user in software development. For example, such software tools may help software developers create, debug, maintain, or otherwise support other programs and applications. Examples of such software development tools include a source code editor and a compiler or interpreter, which are used ubiquitously and continuously. Other software development tools are used more or less depending on the language, development methodology, and individual engineer, often used for a discrete task, such as a debugger or profiler. Software development tools may be discrete programs, executed separately—often from the command line—or may be parts of a single large program, called an integrated development environment (IDE). Furthermore, such software development tools assist the software developer in designing, coding and testing, such as from the requirements inputted by the software developer. Designing refers to the process in creating digital designs for a variety of purposes. Coding refers to creating the programming code which provides instructions to a computing device to perform certain actions. Testing refers to the process of evaluating and verifying that a software or application does what it is supposed to do. While such software development tools assist the software developer in designing, coding, and testing, such software development tools do not assist the software developer in ideating (generating ideas) or generating such designs, code, and tests based on such ideations. Ideation is the process of generating ideas and solutions. By not generating such ideations or taking into consideration such ideations, the assistance provided by the software development tool in designing, coding, and testing is limited. As a result, such software development tools are deficient in assisting users, such as software developers, in designing, coding, and testing by not ideating or generating designs, code, and tests based on such ideations.

Embodiments of the present disclosure improve such technology by receiving a requirement to be used in ideation. A requirement, as used herein, refers to a necessary condition that is required in the design, code, and/or test. The intent associated with the received requirement is then identified. An intent, as used herein, refers to the actions to be performed to accomplish the purpose or objective of the requirement. For example, suppose a requirement is to have a user log into the system using his/her user identification and password. Then the intent associated with such a requirement is to have a correct set of user identification and password in order to allow the user to log into the system. Otherwise, the user will be prevented from logging into the system. In one embodiment, each intent is associated with a requirement as well as one or more inputs and a final output. A pre-requirement and a post-requirement to the received requirement are then identified from a list of requirements. A pre-requirement, as used herein, refers to the requirement that is listed prior to the received requirement in the list of requirements. A post-requirement, as used herein, refers to the requirement that is listed after the received requirement in the list of requirements. Upon identifying the pre- and post-requirements, the intents associated with such requirements are identified. Upon identifying the intents for the received requirement and the pre- and post-requirements, such intents are joined to generate ideation scenarios in terms of actions based on such joined intents. An ideation scenario, as used herein, refers to the idea or solution based on a requirement. In one embodiment, such ideation scenarios include the intents along with the associated requirements, inputs and final outputs. In this manner, the deficiency in software development tools is overcome by generating ideas as well as generating designs, code, and tests based on such ideations. Furthermore, in this manner, there is an improvement in the technical field involving software development tools.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for generating ideation scenarios, the method comprising:
receiving a requirement to be used in ideation;
identifying a first intent associated with said received requirement;
identifying a pre-requirement and a post-requirement to said received requirement from a list of requirements;
identifying a second intent associated with said pre-requirement and a third intent associated with said post-requirement; and
generating ideation scenarios in terms of actions based on said first, second and third intents.

2. The method as recited in claim 1 further comprising:
generating code, designs and/or testing for one or more of said generated ideation scenarios.

3. The method as recited in claim 1 further comprising:
receiving a weight for each of said received requirement, said pre-requirement and said post-requirement corresponding to a level of priority; and
prioritizing said generated ideation scenarios based on said received weight for each of said received requirement, said pre-requirement and said post-requirement.

4. The method as recited in claim 1 further comprising:
presenting said generated ideation scenarios to a user; and
receiving feedback from said user regarding said presented ideation scenarios.

5. The method as recited in claim 1 further comprising:
presenting a generated ideation scenario to a user; and
using one or more of said first, second and third intents as a search query to identify ideation scenarios across industries and domains that are within a threshold degree of similarity to said presented ideation scenario.

6. The method as recited in claim 5 further comprising:
identifying one or more ideation scenarios across said industries and said domains that are within said threshold degree of similarity to said presented ideation scenario;
presenting said one or more ideation scenarios identified across said industries and said domains to said user; and
generating code, designs and/or testing for said presented one or more ideation scenarios identified across said industries and said domains.

7. The method as recited in claim 5 further comprising:
identifying said presented ideation scenario as being new in response to not identifying one or more ideation scenarios across said industries and said domains that are within said threshold degree of similarity to said presented ideation scenario.

8. A computer program product for generating ideation scenarios, the computer program product comprising one or more computer readable storage mediums having program code embodied therewith, the program code comprising programming instructions for:
receiving a requirement to be used in ideation;
identifying a first intent associated with said received requirement;
identifying a pre-requirement and a post-requirement to said received requirement from a list of requirements;
identifying a second intent associated with said pre-requirement and a third intent associated with said post-requirement; and
generating ideation scenarios in terms of actions based on said first, second and third intents.

9. The computer program product as recited in claim 8, wherein the program code further comprises the programming instructions for:
generating code, designs and/or testing for one or more of said generated ideation scenarios.

10. The computer program product as recited in claim 8, wherein the program code further comprises the programming instructions for:
receiving a weight for each of said received requirement, said pre-requirement and said post-requirement corresponding to a level of priority; and
prioritizing said generated ideation scenarios based on said received weight for each of said received requirement, said pre-requirement and said post-requirement.

11. The computer program product as recited in claim 8, wherein the program code further comprises the programming instructions for:
presenting said generated ideation scenarios to a user; and
receiving feedback from said user regarding said presented ideation scenarios.

12. The computer program product as recited in claim 8, wherein the program code further comprises the programming instructions for:
presenting a generated ideation scenario to a user; and
using one or more of said first, second and third intents as a search query to identify ideation scenarios across industries and domains that are within a threshold degree of similarity to said presented ideation scenario.

13. The computer program product as recited in claim 12, wherein the program code further comprises the programming instructions for:
identifying one or more ideation scenarios across said industries and said domains that are within said threshold degree of similarity to said presented ideation scenario;
presenting said one or more ideation scenarios identified across said industries and said domains to said user; and
generating code, designs and/or testing for said presented one or more ideation scenarios identified across said industries and said domains.

14. The computer program product as recited in claim 12, wherein the program code further comprises the programming instructions for:
identifying said presented ideation scenario as being new in response to not identifying one or more ideation scenarios across said industries and said domains that are within said threshold degree of similarity to said presented ideation scenario.

15. A system, comprising:
a memory for storing a computer program for generating ideation scenarios; and
a processor connected to the memory, wherein the processor is configured to execute program instructions of the computer program comprising:
receiving a requirement to be used in ideation;
identifying a first intent associated with said received requirement;
identifying a pre-requirement and a post-requirement to said received requirement from a list of requirements;
identifying a second intent associated with said pre-requirement and a third intent associated with said post-requirement; and
generating ideation scenarios in terms of actions based on said first, second and third intents.

16. The system as recited in claim 15, wherein the program instructions of the computer program further comprise:
generating code, designs and/or testing for one or more of said generated ideation scenarios.

17. The system as recited in claim 15, wherein the program instructions of the computer program further comprise:
receiving a weight for each of said received requirement, said pre-requirement and said post-requirement corresponding to a level of priority; and
prioritizing said generated ideation scenarios based on said received weight for each of said received requirement, said pre-requirement and said post-requirement.

18. The system as recited in claim 15, wherein the program instructions of the computer program further comprise:
presenting said generated ideation scenarios to a user; and
receiving feedback from said user regarding said presented ideation scenarios.

19. The system as recited in claim 15, wherein the program instructions of the computer program further comprise:
presenting a generated ideation scenario to a user; and
using one or more of said first, second and third intents as a search query to identify ideation scenarios across industries and domains that are within a threshold degree of similarity to said presented ideation scenario.

20. The system as recited in claim 19, wherein the program instructions of the computer program further comprise:
identifying one or more ideation scenarios across said industries and said domains that are within said threshold degree of similarity to said presented ideation scenario;
presenting said one or more ideation scenarios identified across said industries and said domains to said user; and
generating code, designs and/or testing for said presented one or more ideation scenarios identified across said industries and said domains.
